(19) United States
(12) Patent Application Publication
(10) Pub. No.: US 2008/0098612 A1
(43) Pub. Date: May 1, 2008

(54) Roof Drying Apparatus

(76) Inventor: Gary Taylor, Cheltenham (GB)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/813,751

(22) PCT Filed: Jan. 11, 2006
(86) PCT No.: PCT/GB06/00093

§ 371 Date: Jul. 11, 2007

(30) Foreign Application Priority Data
Jan. 13, 2005 (GB) 0500608.5

(51) Int. Cl. F26B 3/04; E01C 23/14; E01H 1/08; F16L 11/00

(52) U.S. Cl. 34/86; 138/118

(57) ABSTRACT

Roof drying apparatus (10) comprises:

a housing (12) having one or more air inlets (26) and an air outlet (40);

an internal combustion engine (24) mounted in the housing (12); and

a blower mechanism (34) which is drivable by the engine (24) for forcing air out of the air outlet (40) of the housing (12).

The apparatus is characterised in that an exhaust outlet (30) of the engine (24) is positioned to discharge exhaust gas in or onto an air flow path which extends from the or at least one of the air inlets (26) to the air outlet (40) so that, in use, at least a portion of the air outputted from the air outlet (40) by the blower mechanism (34) is pre-heated by the exhaust gas of the engine (24).

A duct device for adapting an internal combustion engine handheld air blower device to form such roof drying apparatus is also provided.

The present invention relates to roof drying apparatus, to a duct device for producing roof drying apparatus, and to a method of drying a roof using such apparatus.

In regions with climates having frequent precipitation, new flat roofing or repairs to existing flat roofing cannot be readily undertaken whilst the existing structure and/or substrate is retaining standing water or is simply just wet. Consequently, time is wasted removing the standing water, and/or drying out the structure/substrate prior to commencing laying of roof material.

Air blower devices, such as commonly available leafblowers, have been utilised to physically blow water off a structure/substrate. However, these devices only blow ambient temperature air, and thus do not rapidly dry out a structure/substrate.

It is also known to utilise naked flame devices, such as blowtorches and the like, as well as electrically powered devices, such as heat guns and hairdryers. However, health and safety regulations now impose strict workplace guidelines on the use of tools with exposed electrical elements and wiring in wet places, and the insurance coverage required when contemplating naked flame tools makes their use cost-prohibitive.

The present invention seeks to provide a solution to this problem.

According to a first aspect of the present invention, there is provided roof drying apparatus comprising: a housing having one or more air inlets and an air outlet; an internal combustion engine mounted in the housing; and a blower mechanism which is drivable by the engine for forcing air out of the air outlet of the housing, characterised in that an exhaust outlet of the engine is positioned to discharge exhaust gas in or onto an air flow path which extends from the or at least one of the air inlets to the air outlet so that, in use, at least a portion of the air outputted from the air outlet by the blower mechanism is pre-heated by the exhaust gas of the engine.

Preferable and/or optional features of the first aspect of the invention are set forth in claims 2 to 6, inclusive.

According to a second aspect of the invention, there is provided a duct device for adapting an internal combustion engine handheld air blower device to form roof drying apparatus as claimed in any one of the preceding claims, the device comprising a tubular body having two openings, a first one of the openings being adapted for connection to an engine compartment exhaust outlet of a housing of the air blower device to direct exhaust gas into the duct device, and a second one of the openings being adapted for connection to a blower compartment air inlet of the housing of the air blower device, so that, in use, at least a portion of air which is outputted from a blower mechanism air outlet of the blower device is pre-heated by exhaust gas of the engine of the blower device being drawn from the engine compartment exhaust outlet along the duct device and through the blower compartment air inlet.

Preferable and/or optional features of the second aspect of the invention are set forth in claims 8 to 11, inclusive.

The present invention will now be more particularly described, by way of example only, with reference to the accompanying drawings, in which:

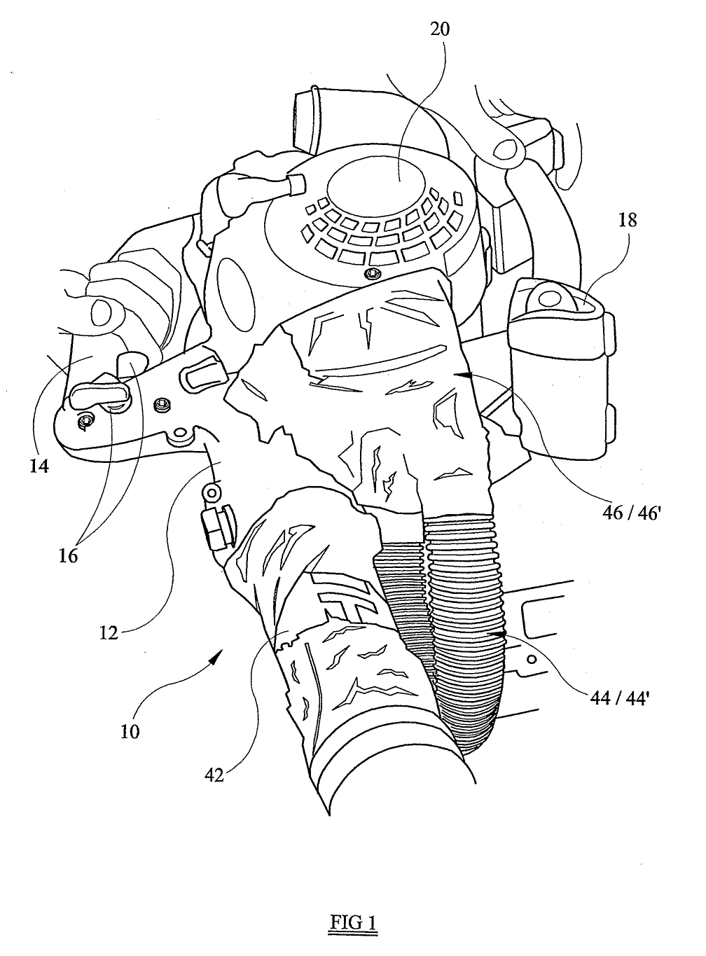

FIG. 1 is a perspective view of one embodiment of roof drying apparatus, in accordance with the first aspect of the invention, having a duct device in accordance with the second aspect of the invention;

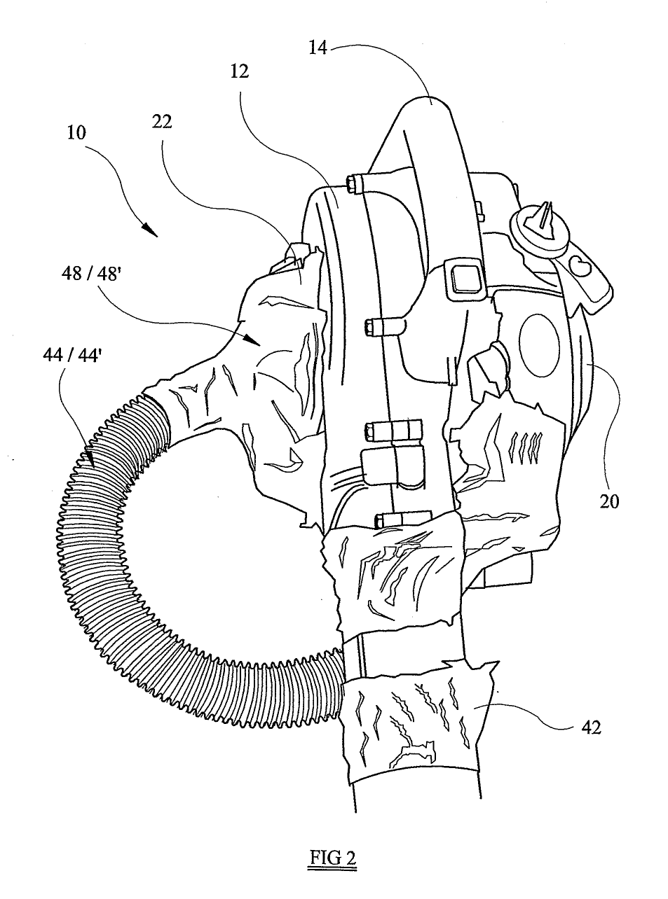

FIG. 2 is a top plan view of the roof drying apparatus and duct device shown in FIG. 1;

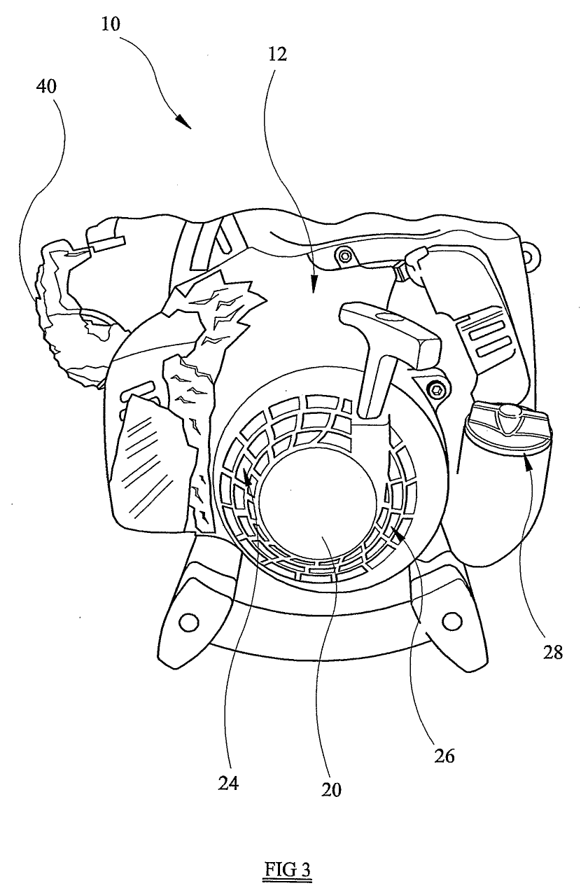

FIG. 3 is a view from one side of the roof drying apparatus with the duct device and air discharge nozzle removed;

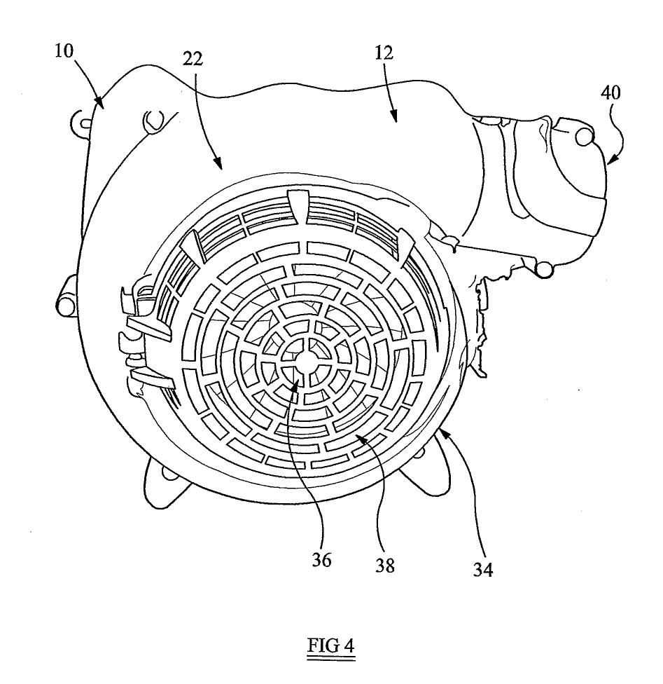

FIG. 4 is a view from the other side of the roof drying apparatus shown in FIG. 3; and

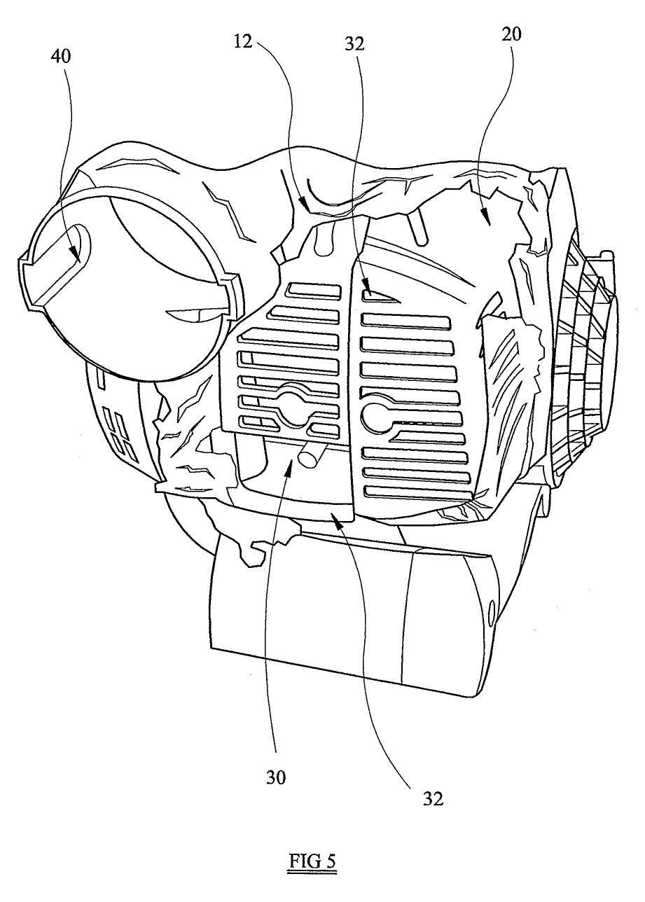

FIG. 5 is a perspective view from the front of the roof drying apparatus shown in FIG. 3.

Referring now to the drawings, there is shown roof drying apparatus 10 which comprises a housing 12 having a handle or grip 14 with user operable controls 16, feet or a stand 18 on the bottom of the housing 12, a drive motor compartment 20 provided in one part of the housing 12, and a blower compartment 22 provided in another part of the housing 12.

An internal combustion (i.c.) engine 24 is located in the drive motor compartment 20 of the housing 12, and an ambient air inlet 26 of the roof drying apparatus 10 is formed in an outside wall of the housing 12 and adjacent to the i.c. engine 24 air intake (not shown). A fuel inlet 28 projects from the housing 12 for receiving fuel to run the i.c. engine 24, and an exhaust outlet 30 of the i.c. engine 24 is positioned in or adjacent to an air outlet 32 of the drive motor compartment 20 (see FIG. 5).

A blower mechanism 34 is provided in the blower compartment 22 of the housing 12. The blower mechanism 34 comprises a blower wheel 36 which is mounted for rotation in a generally spiral shaped cavity of the blower compartment 22. The blower wheel 36 is axially coupled to a drive shaft of the i.c. engine 24. The blower compartment 22 has an air intake 38 formed in one side thereof, and an air outlet 40 of the roof drying apparatus 10 is formed at the top of the blower compartment 22.

As shown in FIGS. 1 and 2, a removable air discharge nozzle 42 is releasably attached to the housing 12 at the air outlet 40 of the roof drying apparatus 10.

The blower wheel 36 of the blower mechanism 34 includes vanes which, when moving, cooperate with the generally spiral shaped cavity to entrain air and accelerate it for forcible discharge from the air outlet 40 of the roof drying apparatus 10.

A duct 44 having a generally tubular hollow body extends from the drive motor compartment air outlet 32 to the blower compartment air intake 38. A first opening 46 of the duct 44 is dimensioned to fully cover the drive motor compartment air outlet 32, leaving only the air inlet 26 of the roof drying apparatus 10 open to the ambient environment. A second opening 48 of the duct 44 is dimensioned to fully cover the blower compartment air intake 38.

Due to the duct 44, the blower mechanism 34 draws air along an air flow path which extends from the drive motor compartment air inlet 26, through the drive motor compartment 20, along the duct 44, and through the blower compartment air intake 38.

Since the i.c. engine 24 is positioned directly in the air flow path, the air drawn into the blower compartment 22 by the blower mechanism 34 is pre-heated by the heat energy radiated by the i.c. engine 24.

Furthermore, since the air intake 38 of the blower compartment 22 is only in fluid connection with the drive motor compartment 20 and not in direct fluid communication with the ambient environment, heated air entering the blower compartment 22 is not undesirably cooled by being mixed with ambient temperature air before discharge.

As mentioned above, the exhaust outlet 30 of the i.c. engine 24 is positioned in or adjacent to the drive motor compartment air outlet 32. As such, hot exhaust gas discharged from the exhaust outlet 30 is also entrained in the air being drawn along the duct 44 to the blower compartment 22, resulting in further heating of the air moving along the produced air flow path.

The roof drying apparatus can have more than one ambient air inlet formed in the drive motor compartment. However, in this case, the i.c. engine is preferably positioned in an air flow path from each air inlet to the blower compartment.

Any suitable type of drive motor can be used, and the drive motor may be an electric motor instead of an i.c. engine.

The roof drying apparatus described above is handheld and portable, without trailing wires or cords, thus making it a simple matter to direct a powerful steam of heated air at a body of water and/or a damp roof structure and/or substrate. The apparatus can be easily moved to other areas of the roof to perform further drying.

The above-mentioned duct 44 can be provided as an independent device for connection to an existing air blower device, such as a leafblower, in order to produce roof drying apparatus as previously described.

In this case, the duct device 44′ (see FIGS. 1 and 2) has the tubular body with openings at its ends. A first one of the openings 46′ is adapted for connection to a drive motor compartment of a housing of the air blower device, and a second one of the openings 48′ is adapted for connection to a blower compartment of the housing of the air blower device.

Both the first and second opening 46′ and 48′ are dimensioned to fully cover an air outlet of the drive motor compartment and an air intake of the blower compartment, respectively.

Suitable fastening means are utilised to releasably secure the duct device to the air blower device.

This arrangement provides the same benefits as mentioned above, in that a blower mechanism of the air blower device is prevented from directly drawing ambient air into the blower compartment. As such, an air flow path, in which a drive motor of the air blower device is positioned, is again produced from the air inlet of the drive motor compartment to the air outlet of the blower compartment. Consequently, ambient air is only drawn into the housing via the drive motor compartment. The air flows over and around the drive motor, thus being heated, passes along the duct device, and enters the blower compartment. The heated air is then forcibly discharged from an air outlet of the air blower device in the normal manner.

The roof drying apparatus adapted from the air blower device can thus be used as described above for removing standing water from, and/or drying out, a roof structure and/or substrate.

The duct and/or duct device may include a variably openable and closable aperture to allow ingress of ambient air for mixing with the heated air flowing to the blower compartment. This enables temperature regulation of the air stream discharged from the roof drying apparatus.

Although the roof drying apparatus and adapted air blower device described above are primarily intended to dry flat roof structures and/or roof substrates, they could also be used for drying pitched roof structures and/or substrates.

The drive motor compartment may have other vents to allow cooling of the drive motor.

It is thus possible to provide roof drying apparatus which is handheld and portable, and which does not utilise a naked flame or have exposed electrical heating elements. It is also possible to provide a duct device by which an existing air blower device can be adapted to produce roof drying apparatus.

The embodiments described above are given by way of examples only, and modifications will be apparent to persons skilled in the art without departing from the scope of the invention as defined by the appended claims.

1-11. (canceled)

12. Roof drying apparatus for drying a roof, the apparatus comprising:
a housing having one or more air inlets and an air outlet;
an internal combustion engine mounted in the housing; and
a blower mechanism which is drivable by the engine for forcing air out of the air outlet of the housing, characterised in that
an exhaust outlet of the engine is positioned to discharge exhaust gas in or onto an air flow path which extends from the or at least one of the air inlets to the air outlet so that, in use, at least a portion of the air outputted from the air outlet by the blower mechanism is pre-heated by the exhaust gas of the engine.

13. Apparatus as claimed in claim 12, wherein the engine is positioned in an or the air flow path from the or each air inlet to the air outlet of the housing.

14. Apparatus as claimed in claim 12, wherein the roof drying apparatus is a cordless handheld portable device.

15. Apparatus as claimed in claim 12, wherein the housing has a single said air inlet in fluid communication with the air outlet.

16. Apparatus as claimed in claim 12, wherein the said air outlet of the housing is the sole air outlet.

17. Apparatus as claimed in claim 12, wherein the housing includes a duct which leads from the engine to the blower mechanism, and along which the or each said air flow path extends.

18. A duct device for adapting an internal combustion engine handheld air blower device to form roof drying apparatus as claimed in any one of the preceding claims, the device comprising:
a tubular body having two openings, and
fastening means for releasably securing the tubular body to a housing of the air blower device,
a first one of the openings being connectable via the fastening means to an engine compartment exhaust outlet of the housing of the air blower device to direct exhaust gas into the duct device, and
a second one of the openings being connectable via the fastening means to a blower compartment air inlet of the housing of the air blower device,
so that at least a portion of air which is outputted from a blower mechanism air outlet of the blower device is pre-heated by exhaust gas of the engine of the blower device being drawn from the engine compartment exhaust outlet along the duct device and through the blower compartment air inlet.

19. A duct device as claimed in claim 18, wherein the first and second openings of the tubular body are releasably connectable to the blower device.

20. A duct device as claimed in claim 18, wherein the second opening of the tubular body is dimensioned to cover the blower compartment air inlet of the blower device.

21. A duct device as claimed in claim 18, wherein the first opening of the tubular body is dimensioned to cover the engine compartment exhaust outlet.

22. A duct device as claimed in claim 18, wherein the first opening of the tubular body is dimensioned to cover the exhaust outlet of the engine.
